(19) United States
(12) Patent Application Publication
(10) Pub. No.: US 2016/0315988 A1
(43) Pub. Date: Oct. 27, 2016

(54) METHOD AND APPARATUS FOR COLLABORATIVE ENVIRONMENT SHARING

(71) Applicant: Daniel Joseph Lyons, Medina, OH (US)

(72) Inventor: Daniel Joseph Lyons, Medina, OH (US)

(21) Appl. No.: 15/098,397

(22) Filed: Apr. 14, 2016

Related U.S. Application Data
(60) Provisional application No. 62/151,608, filed on Apr. 23, 2015.

(51) Int. Cl. H04L 29/06; H04L 12/26

(52) U.S. Cl. CPC H04L 65/601; H04L 43/106

(57) ABSTRACT

Methods and apparatus for collaborative environment sharing comprise transmitting a video stream captured by a local device to one or more remote devices, receiving, at the local device, remote visual cue data related to the video stream from the one or more remote devices, wherein the remote visual cue data comprises one or more visual cues associated with objects identified in the video stream by users of the one or more remote devices, transforming the visual cue data to correctly position the one or more visual cues with an updated location of the objects in the video stream at the local device and superimposing the one or more visual cues over the video stream displaying on the local device continuously as a user of the local device relocates the local device.

### CROSS-REFERENCE TO RELATED APPLICATION

This application claims benefit of U.S. Provisional Patent Application No. 62/151,608, filed Apr. 23, 2015, which is incorporated herein by reference in its entirety.

### BACKGROUND OF THE INVENTION

1. Field of the Invention

Embodiments of the present invention generally relate to methods and apparatuses for collaborative environment sharing.

2. Description of the Related Art

Typical video conferencing systems are effective at allowing people to conduct meetings in which participants can see each other and can collaboratively work on documents, for example, displayed on a computing device. Such systems utilize video capture devices to allow participants to see each other. Such systems also generally have application sharing capabilities in which one participant can share their display or portions of their display where applications are being executed. Furthermore, these video conferencing systems typically permit participants to collaboratively engage in providing input to the shared information in the video conference. This type of collaboration is representative of a structured meeting in which people traditionally came together in a meeting room and collaborated on a document, spreadsheet, or the like. Current video conferencing technology is well suited for this type of collaboration and has allowed people to effectively have structured meetings without needing to be physically collocated.

Although typical video conferencing systems have allowed people to have structured meeting from physically different locations, there are many other scenarios where physically meeting someone enables a much broader range of tasks to be accomplished. For example, being with a tour guide while in a foreign city is significantly more helpful than having the tour guide available for a video call because the tour guide can immediately recognize their surroundings and physically point you towards a landmark. Similarly, shopping is enhanced by the physical presence of another, as both individuals can view the items together and point to features to illustrate likes and dislikes. There are numerous other scenarios where being physically together if much easier for solving various types of tasks that cannot be addressed by existing technology. However, sometimes physical presence is impossible, unfeasible or inefficient.

Therefore, there is a need in the art for technology that allows a person to reap the benefits of the physical presence of another person through mobile video transmission.

### SUMMARY OF THE INVENTION

Embodiments of the present invention relate to methods and apparatus for collaborative environment sharing.

Other and further embodiments of the present disclosure are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates collaborative environment sharing in accordance with exemplary embodiments of the present invention;

FIG. 2 illustrates a local device transmitting video of objects in its environment to a remote device over a network in accordance with exemplary embodiments of the present invention;

FIG. 3 illustrates a local device transmitting video of objects in its environment to a remote device over a network as in FIG. 2, with visual cues from a remote user in accordance with exemplary embodiments of the present invention;

FIG. 4 illustrates a local device transmitting video of objects in its environment to a remote device over a network with visual cues created in FIG. 3, and the visual cues being rendered on both the local and remote device in accordance with exemplary embodiments of the present invention;

FIG. 5 illustrates a local device transmitting video of objects in its environment to a remote device over a network with the local user creating visual cues in accordance with exemplary embodiments of the present invention;

FIG. 6 illustrates a local device transmitting video of objects in its environment to a remote device over a network with visual cues rendered on both the local and remote device in accordance with exemplary embodiments of the present invention;

FIG. 7 illustrates object detection and visual cue transformation on the local and remote devices to correct for temporal synchronization in accordance with exemplary embodiments of the present invention.

FIG. 8 illustrates a block diagram of a portion of the collaborative environment sharing system used to maintain visual cue and object alignment in accordance with exemplary embodiments of the present invention;

FIG. 9 illustrates a block diagram of a portion of the collaborative environment sharing system used to maintain visual cue and object alignment in accordance with exemplary embodiments of the present invention;

FIG. 10 illustrates examples of various menus that may be implemented at the local and remote devices to facilitate visual cue creation in accordance with exemplary embodiments of the present invention;

FIG. 11 illustrate other examples of various menus that may be implemented at the local and remote devices to facilitate visual cue creation in accordance with exemplary embodiments of the present invention;

FIG. 12 depicts a block diagram of a computer system for implementing a portion of the system shown in FIG. 1 in accordance with exemplary embodiments of the present invention;

FIG. 13 depicts a flow diagram for a method of collaborative environment sharing in accordance with exemplary embodiments of the present invention; and

FIG. 14 depicts a computer system that can be utilized in various embodiments of the present invention, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to a method and apparatus for collaborative environment sharing. In some embodiments, a user of the system described herein can share a real-time video stream of their surroundings with others who are not physically present, via the user's computing device, e.g., a mobile phone or the like. The local user is able to direct a remote user's attention to a particular region of the video stream by the use of visual cures. Similarly, remote users can draw the local user's attention to particular regions of the video stream containing certain objects by the use of their own visual cues. In order to maintain the visual cues accuracy, as time lapses and the local user's device shifts, the visual cues are transformed accordingly. Those of ordinary skill in the art will recognize that “local” and “remote” are relative terms where local indicates an example of a device that captures a video stream, while remote represents the device the stream is transmitted to. Additionally, the local and remote devices are interchangeably usable in the present invention relative to each other.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

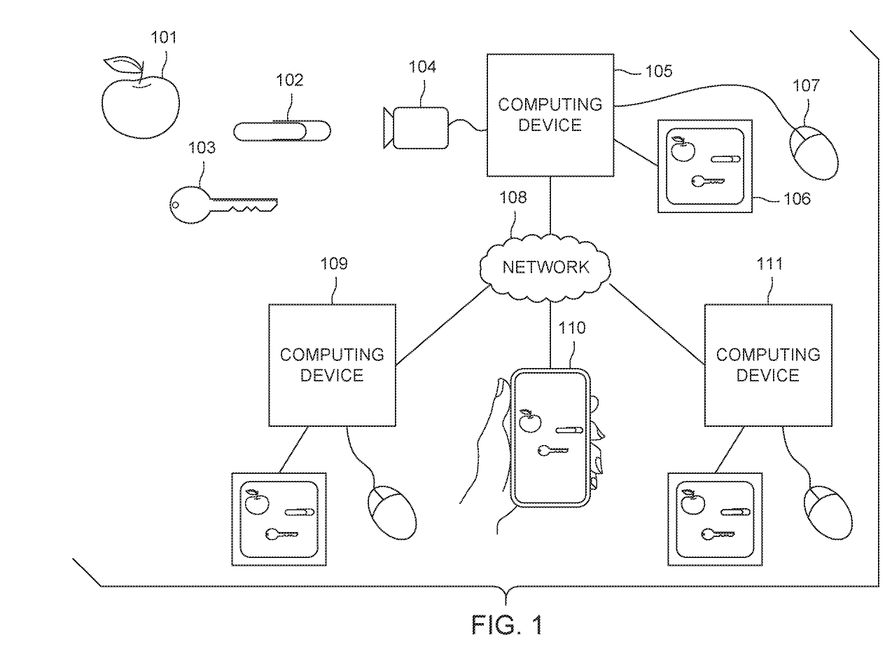

As illustrated in FIG. 1, one such embodiment consists of a computing device 105 with a video capture device 104, display device 106, and input device 107. The computing device 105, video capture device 104, input device 107 and display device 106 may be individual components as illustrated, integrated together into a single device or some combination thereof such as a mobile telephone or tablet computer without changing the intent of the invention, communicating over network 108. For example, in some embodiments, video capture device 104 may be an embedded image/video capture device on a smartphone, television, or computer, or a separate external image/video capture device communicatively coupled to a smartphone, television, or computer via standard wired or wireless technology. The video capture device captures a video stream of areas of interest of one user's local environment such as object 101, object 102 and object 103. The video stream of the user's local environment is displayed on the local display device 106 while also being transmitted over network 108 to other devices for display, e.g., computing device 109, computing device 110, and computing device 111. According to one embodiment, devices 109-111 have been specifically invited to view the local user's video stream. In other embodiments, the local user's video stream may be publicly accessible and selectable by multiple remote users over network 108 via their respective computing devices. According to some embodiments, others can view a user's video stream by initiating a connection that allows for video transmission between devices using SIP, H.323, proprietary methods, or other implementations. The connection may be established directly between the devices or with the aid of one or more server devices residing within the network 108. In some instances, the video stream of the local user is accessible publicly or only available to private invitees based on invitations.

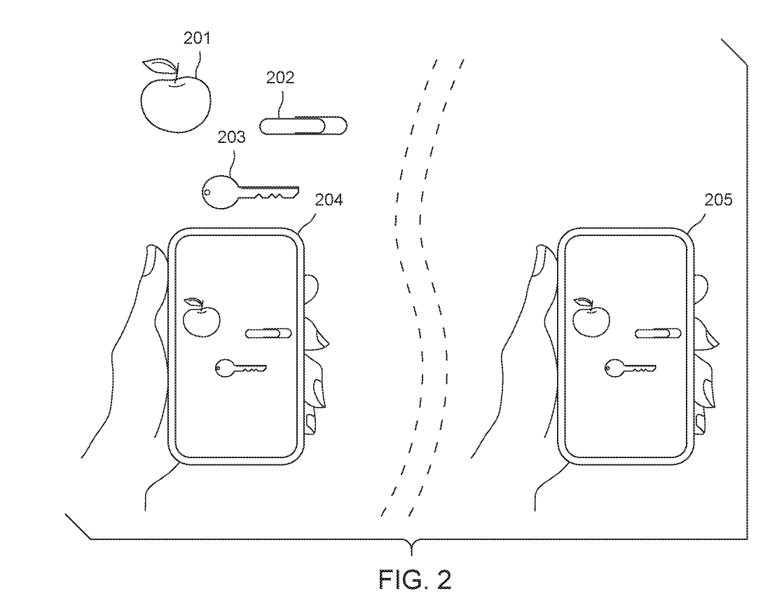

FIG. 2 illustrates a scenario in which a user with local device 204 wishes to have a conversation in regards to objects 201, 202, and 203 with remote users, for example, a user with remote device 205. The user directs their video capture device 104 towards the objects of interest to generate a video stream displayed on the local device 204. The same video stream is then transmitted to a second user using the remote device 205 and is able to observe the objects of interest to the local user. According to some embodiments, the video stream may be transmitted utilizing one or more internet protocols such as RTP, RTCP, RTSP, RTMP, or HTTP or utilizing a proprietary protocol. In most instances, audio streams would additionally be transmitted between local device 204 and remote device 205 using an open or proprietary internet protocol allowing the users to have a conversation about what they are jointly observing. Those of ordinary skill in the art will recognize that the present invention is not limited to transmitting video according to the previously listed protocols and other protocols may be used interchangeably.

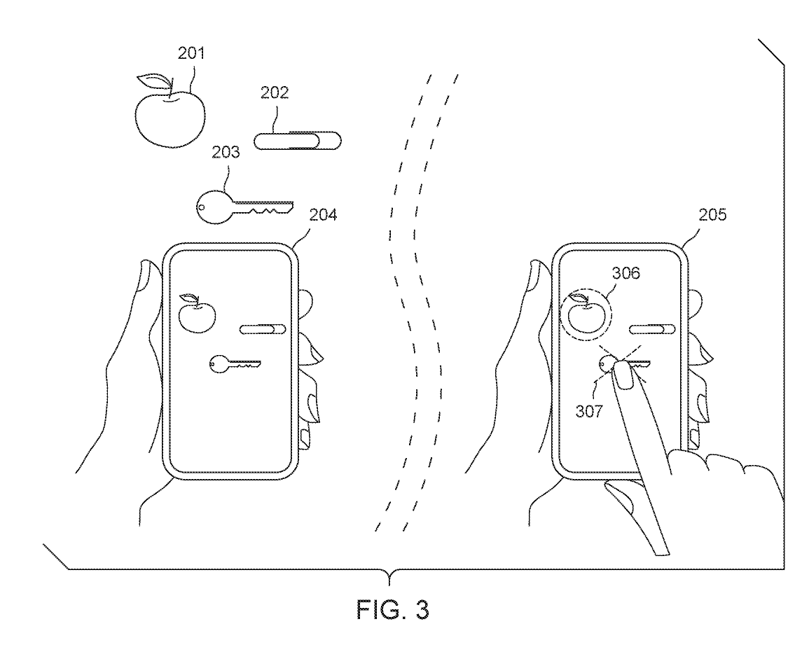

FIG. 3 illustrates a remote user providing input on the video stream. In this embodiment, the user of remote device 205 wishes to provide input in regards to how the local user of local device 204 should interact with the objects 201 and 203. According to some embodiments, input is provided by, but not limited to, finger touch, stylus, mouse, or the device capable of interpreting gestures through movement detection. In this embodiment as illustrated in FIG. 3, the remote user creates visual cues 306 and 307 on the remote device 305 that are transmitted and displayed over the video stream displayed on local device 204. Accordingly, a remote user can guide a local user in which objects they might or might not be interested in. In one embodiment, the video stream from the local device 204 may be of a city street, and the remote user may create visual cues to guide the user through the streets to a particular location. In another embodiment, the video stream from the local device 204 may be of a store and the remote user can indicate via visual cues what items the local user should purchase and should avoid purchasing. Those of ordinary skill in the art will recognize that these embodiments do not limit the present invention, and many different types of visual cues are contemplated by the present invention and may be created by a remote user and transmitted to the local user, and vice versa.

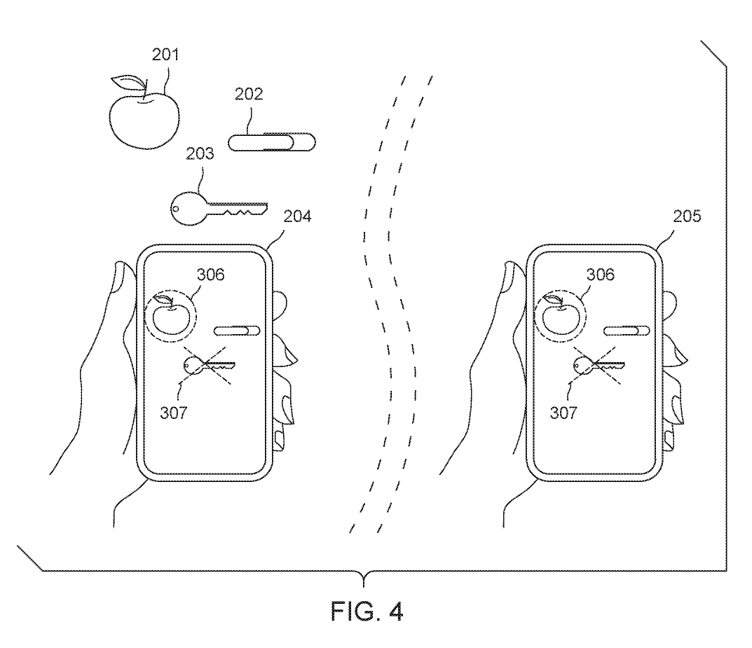

FIG. 4 provides an illustration of what is observed on both the local device 204 and remote device 205 after the visual cues 306 and 307 propagate through the network 108 to the local device 204. In this illustration, the local device now displays the shared video stream superimposed with visual cues 306 and 307 on the original objects 201, 202, and 203 in the environment. In some embodiments, visual cues are stored in a common format such as a vector graphics image format, encapsulated in a proprietary format that incorporates the visual cue and relevant information allowing the visual cue to be properly interpreted when received by other devices, and transmitted through the network utilizing common internet protocols such as TCP, though those of ordinary skill in the art will recognize that format and transmission means are not limited thereto.

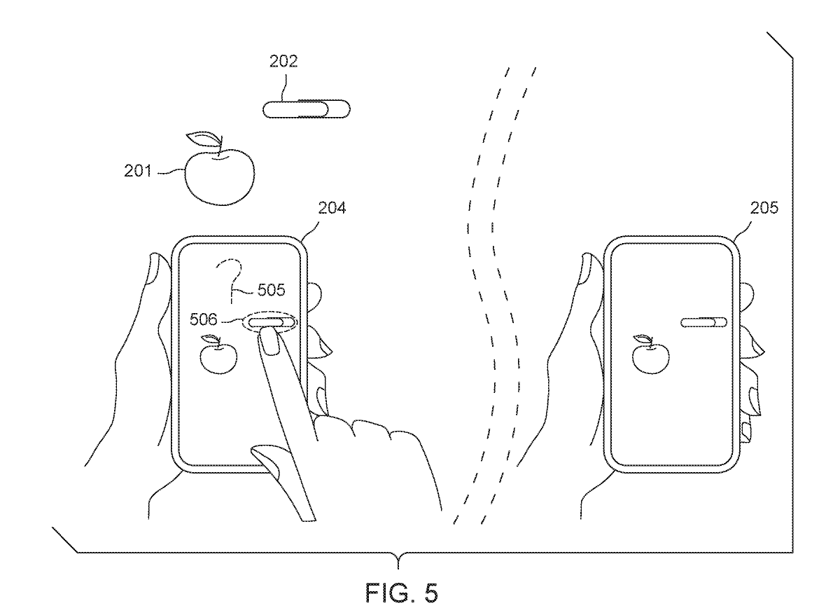

FIG. 5 provides an illustration of how visual cues may also originate from the local device 204. In this embodiment, the local user creates visual cues 505 and 506 in reference to physical objects 201 and 202.

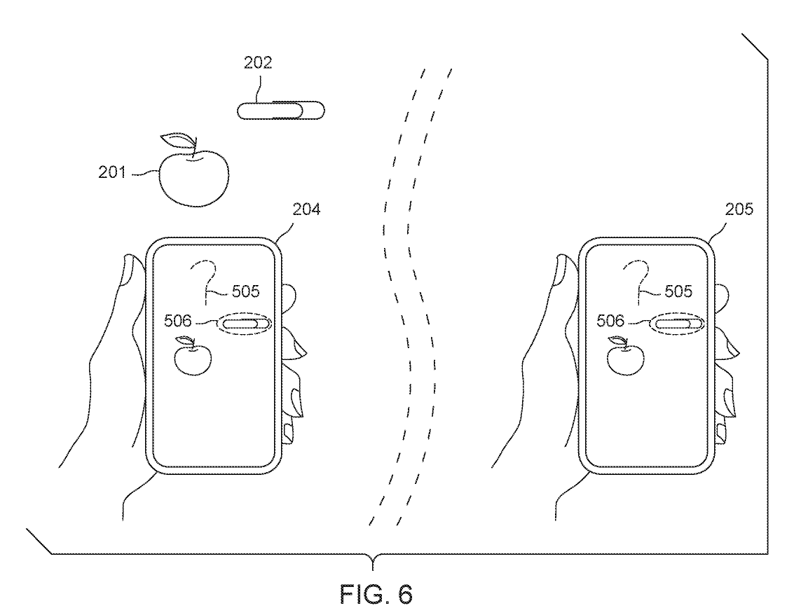

FIG. 6 provides an illustration of what will be observed at both the local device 204 and remote device 205 after the visual cues 505 and 506 propagate through the network 108 to the remote device 205. In this illustration, both the local and remote devices now contain visual cues 505 and 506 superimposed on the video stream of the local user's environment generated by the local device 204. In some embodiments, visual cues may be stored in a common format such as a vector graphics image format, encapsulated in a proprietary format that incorporates the visual cue and relevant information allowing the visual cue to be properly interpreted when received by other devices, and transmitted through the network utilizing common internet protocols such as TCP, though those of ordinary skill in the art will recognize that format and transmission means are not limited thereto.

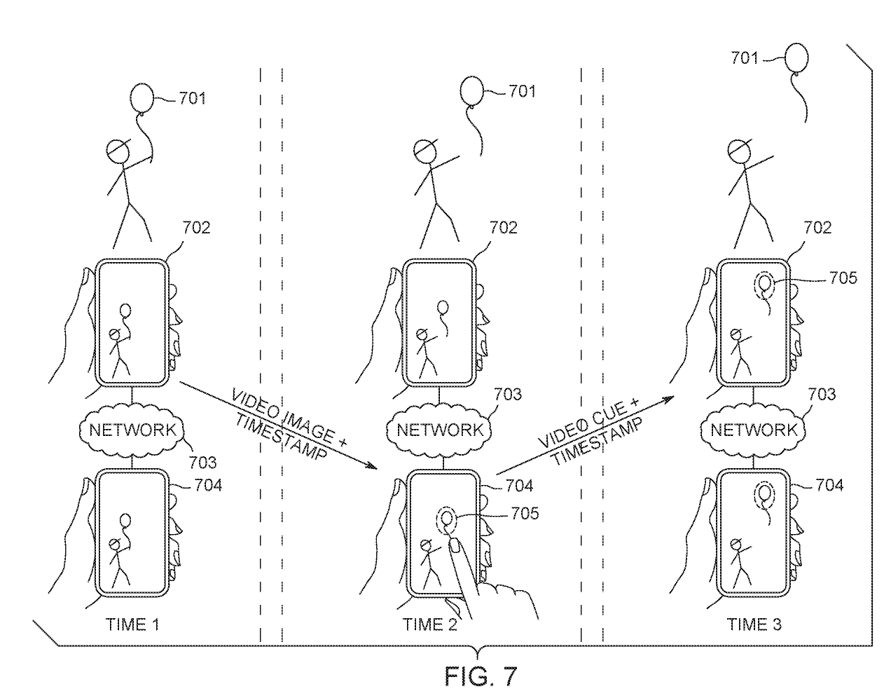

FIG. 7 provides an illustration of the process of aligning visual cues to physical objects in a video stream in the collaborative environment illustrated in FIG. 1 distributed across a network 108. At “Time 1” in FIG. 7, a video stream is generated by local device 702 to be transmitted to and shared with remote device 704. The video stream observed on the remote device 704 at “Time 1” is slightly delayed (due to natural data transmission times) as compared to the video stream observed on the local device 702. “Time 2” represents the time when the video frame corresponding to “Time 1” being captured by local device 702 is received and displayed on remote device 704. At “Time 2”, the remote user of device 704 creates a visual cue 705 they wish to share with the user of local device 702. The visual cue 705 is received by the local device 702 at “Time 3”.

If the local device 702 simply displays the visual cue 705 in the drawn location selected by the remote user of device 704, the visual cue 705 may no longer correspond to the intended object 701 due to object movement in the video stream. Accordingly in one embodiment, both the video stream and the visual cues are associated with timestamps to determine how much time has elapsed since a video frame or visual cue was created. In other embodiments, other registration means may be used to determine elapsed time since visual cue creation. By using the elapsed time information and motion prediction of objects in the video stream, the local device 702 compensates for the movement of object 701 by transforming the location visual cue 705 to correspond to the new location of object 701 when the visual cue 705 is displayed at the local device 702.

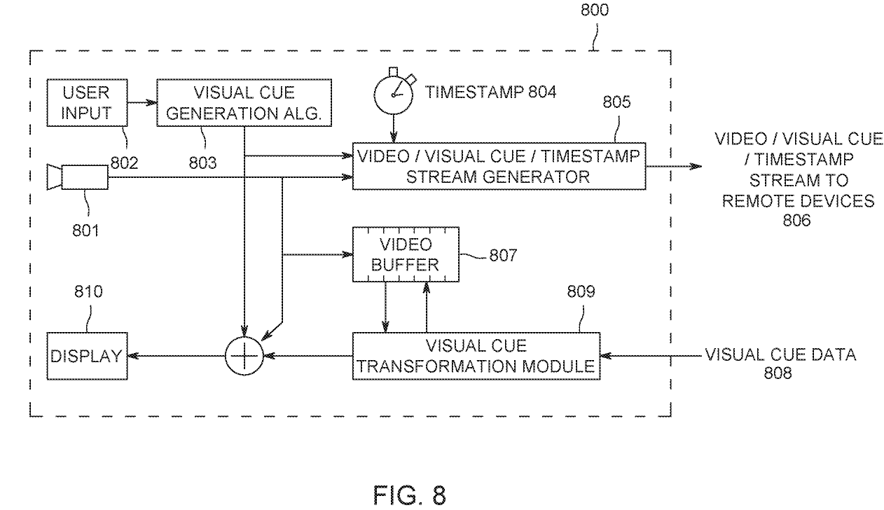

FIG. 8 provides a detailed explanation of the processing within the local device 800, used to keep visual cues aligned to physical objects within a video in accordance with some embodiments of the present invention. A video capture device 801 (e.g., a mobile phone camera) is used to capture the video stream that is to be displayed on a local device as well as one or more remote devices. User input 802 from the local device 800 is forwarded to the visual cue generation algorithm 803 which interprets the user input 802 and creates a corresponding visual cue to be displayed along with the video stream. In one embodiment, a timestamp mechanism is used to record the time (e.g. timestamp 804) at which various video frames were created. The timestamp mechanism also records the time at which a visual cue was created.

The video stream, visual cues and corresponding timestamp information are collected and transmitted through the network 108 by a stream generator 805 or similar mechanism. The local device 800 receives visual cue data 808 from other devices over the network, wherein the visual cue data 808 comprises visual cue and corresponding timestamp information in relation to the video stream. Because of the various time delays in the network between getting the video from the local device 800 to remote devices and retrieving visual cues from remote devices, the position of visual cues may frequently need to be transformed before they can be displayed. To accomplish this, the local device 800 contains a video buffer 807 which stores video for some period of time sufficient to account for the cumulative delays between when a video frame is recorded and when a corresponding video cue could be received.

The visual cue transformation module (VCTM) 809 receives a visual cue and timestamp in the form of the visual cue data 808 from a remote device. The visual cue transformation module 809 requests the video frame from the video buffer 807 corresponding to the timestamp stored in visual cue data 808. The VCTM module 809 first detects an object in the vicinity of a visual cue in visual cue data 808 from the video frame corresponding to the visual cue timestamp. Object detection within an image may, in some embodiments, utilize one or more image processing techniques such as scale invariant feature transform, edge detection, or blob detection to determine distinguishing attributes of the objects corresponding to the visual cues created by the user. Subsequently, the VCTM module 809 attempts to determine if the object corresponding to the visual cue has moved from its position at the visual cue timestamp in visual cue data 808 in comparison to its position in the video stream being currently displayed on local device 800. If the position of the object of interest has moved, the VCTM module 809 will transform the visual cue corresponding to the new object position. In one embodiment, the transformation of the visual cue may be accomplished by tracking the position of the distinguishing attributes of the previously determined objects as they change over time. Alternatively, in another embodiment the transformation of the visual cue may be accomplished without requiring pre-determination of object features to be tracked by utilizing a visual tracking algorithm such as structured output tracking with kernels method or visual tracking with online multiple instance learning method. The local user device then superimposes both the visual cues generated from the local device 800 and visual cues from remote devices and displays them over the current video input over the network.

In some embodiments, a number of objects (e.g., a car, building, person, and the like) are identified/detected within the video stream. Each of the identified may be selected and highlighted in some manner. In some embodiments, a single selection may provide a first visual cue (e.g., a circle highlight around the object, or highlight the object in first color) while a second selection of the highlighted object may change the visual cue to a second visual cue (e.g., an X across the object, or highlight the object in a second color.) Although a timestamp may be used as described above to help track movement of identified objects, in other embodiments, objects may be tracked without the use of a timestamp. For example, in some embodiments, the each device may identify objects within the video stream. Information about an object selected and/or highlighted on one device may be transmitted to the second device. The second device may use the received information about the object selected to determine the same object in the video stream it is displaying, and select/highlight that object accordingly.

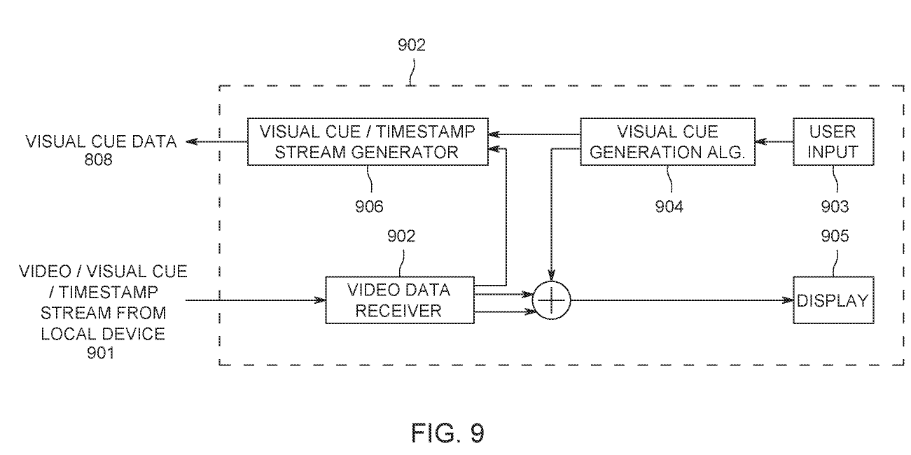

FIG. 9 provides a detailed illustration of the processing within a remote device 900. The remote device 900 receives a video stream, visual cues, and timestamp information 901 from the local device (e.g. local device 800 in FIG. 8) by a video data receiver 902. User input 903 from remote device 900 is received from the remote user in regards to visual cues. A visual cue generation algorithm 904 interprets the user input and creates a corresponding visual cue to be displayed along with the video stream and visual cues from the local device 800 on the remote device display 905. Any visual cues that are created by the remote device 900 are collected with the timestamp corresponding to the frame the visual cue corresponds to as visual cue data 808 and sent to a stream generator 906 which transmits the visual cue data 808 back to the local device 800.

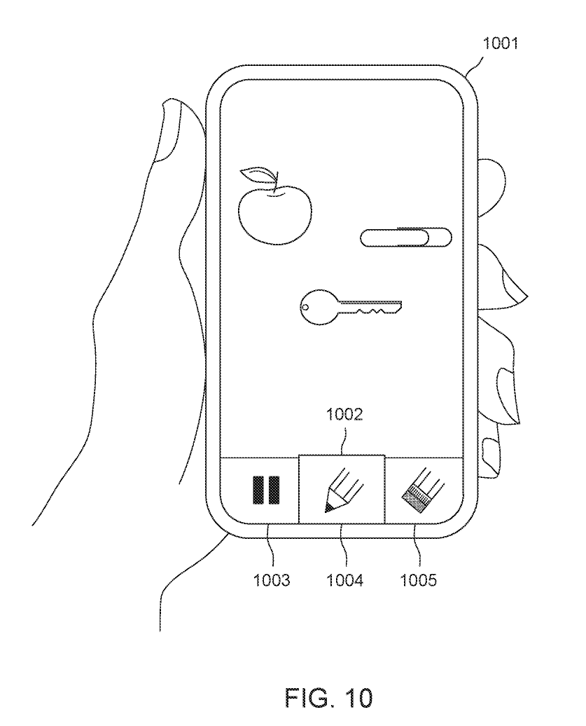

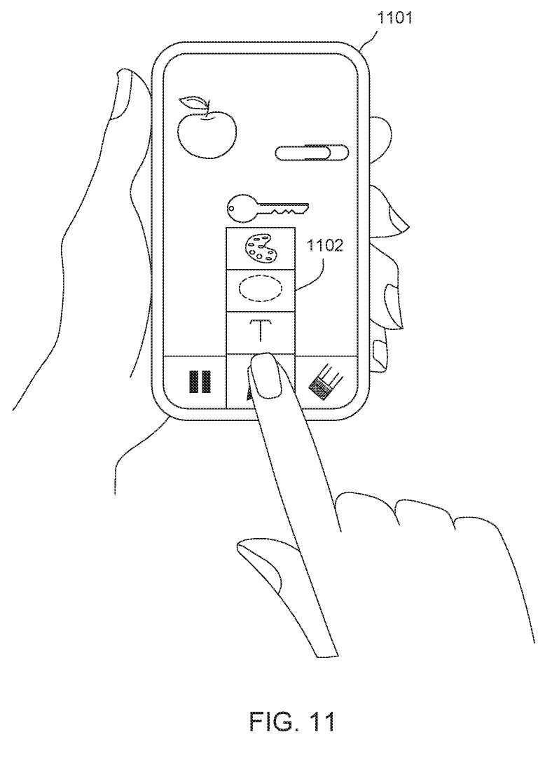

FIG. 10 and FIG. 11 provide example user input menus that are available for creating visual cues at both the local and remote devices according to one embodiment. FIG. 10 presents a simple menu system 1002 that is displayed on device 1001 with several simple buttons. The buttons include, in this embodiment, the ability to pause 1003 the current video to facilitate making simple sketches, a draw button 1004, and an erase button 1005. In FIG. 11, the menu also contains submenus allowing for more specific visual cues such as the ability to draw text, highlight an object, select different colors, or a multitude of other features that may be useful for creating visual cues. The menus are context sensitive allowing the user to have different selections available depending on the scenario they are in. For example, in scenarios such as giving directions it may be useful to have the line in the form of footprints to illustrate where to walk or it may be useful to have buttons in the shape of common tools such as a hammer or wrench in scenarios where building or repairing is the relevant topic. Furthermore, it is not required that all editing be handled through a menu. For example, one may choose to shake the device to erase rather than explicitly requiring the user select an erase button. As a further example, the device may automatically pause the video stream being displayed once user input is detected rather than requiring the user to select a pause button.

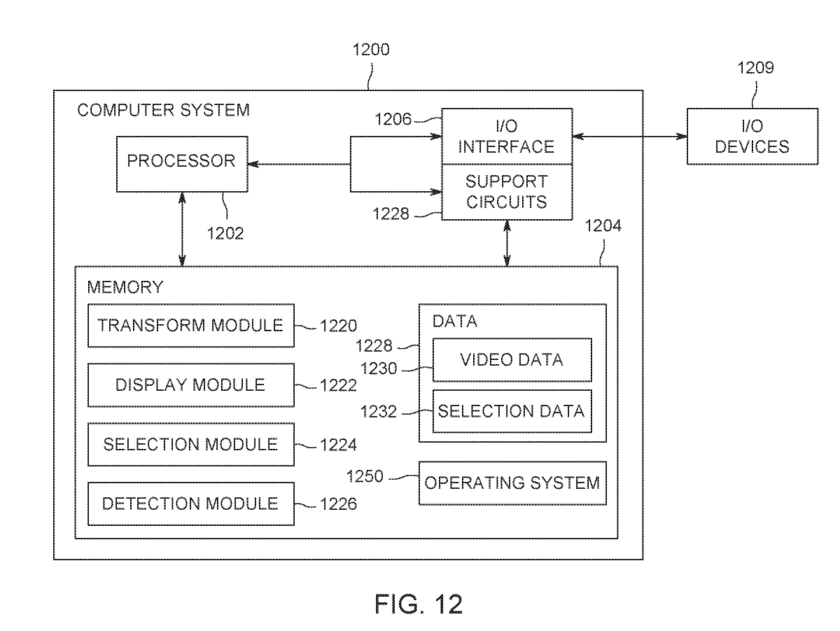

FIG. 12 is a block diagram depicting a computer system 1200 implementing portions of the system shown in FIGS. 1 and 8-9 in accordance with exemplary embodiments of the present invention.

The computer system 1200 includes a processor 1202, various support circuits 1205, and memory 1204. The processors 1202 may include one or more microprocessors known in the art. The support circuits 1207 for the processor 1202 include conventional cache, power supplies, clock circuits, data registers, I/O interface 1206, and the like. The I/O interface 1206 may be directly coupled to the memory 1204 or coupled through the support circuits 1207. The I/O interface 1206 may also be configured for communication with input devices and/or output devices 1209 such as network devices, various storage devices, mouse, keyboard, display, video and audio sensors and the like.

The memory 1204, or computer readable medium, stores non-transient processor-executable instructions and/or data that may be executed by and/or used by the processor 1202. These processor-executable instructions may comprise firmware, software, and the like, or some combination thereof. Modules having processor-executable instructions that are stored in the memory 1204 comprise a transform module 1220, a display module 1222, a selection module 1224 and a detection module 1226. Memory 1204 also contains data 1228 used by the modules 1220-1226, including video data 1230 and selection data 1232. In other instances, portions of the data 1228 are stored on another server (for example, in cloud storage) for access and retrieval.

The computer system 1200 may be programmed with one or more operating systems 1250, which may include OS/2, Linux, SOLARIS, UNIX, HPUX, AIX, WINDOWS, IOS, and ANDROID among other known platforms. The memory 1204 may include one or more of the following: random access memory, read only memory, magneto-resistive read/write memory, optical read/write memory, cache memory, magnetic read/write memory, and the like, as well as signal-bearing media as described below.

Those skilled in the art will appreciate that computer system 1200 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 1200 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1200 may be transmitted to computer system 1200 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

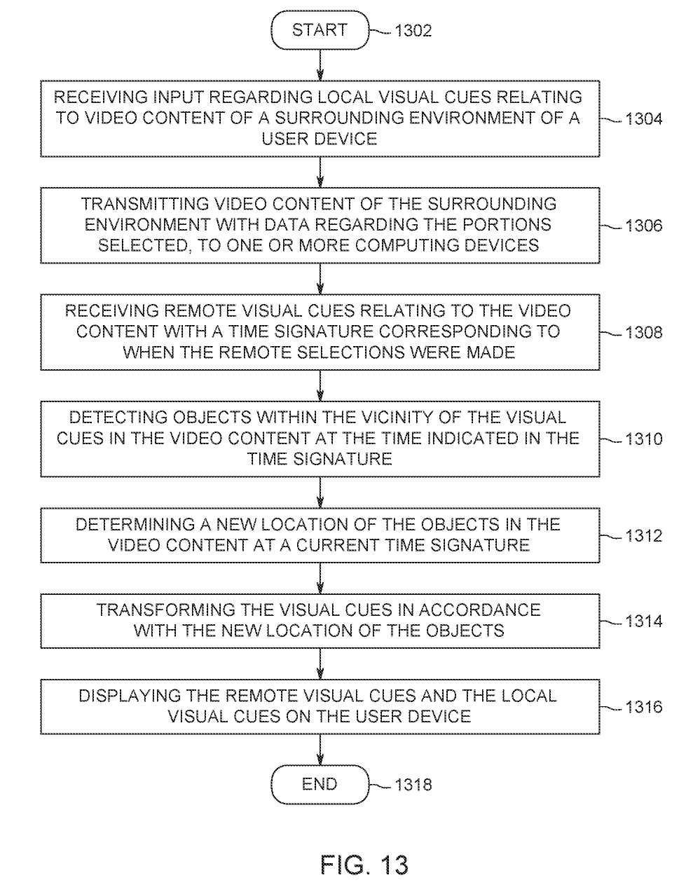

FIG. 13 depicts a flow diagram for a method 1300 of collaborative environment sharing in accordance with exemplary embodiments of the present invention. The method 1300 is an implementation of the modules 1220-1226 operating on the data 1228, as executed by the processor 1202.

The method begins at step 1302 and proceeds to step 1304. At step 1304 input regarding user-selected portions of video content of a surrounding environment is received by the selection module 1224. The user-selected portions may be user created visual cues, e.g. those generated by menu screens shown in FIG. 10-11. The selection module 1224 interprets the selection using the visual cue generation algorithm 803 shown in FIG. 8. In some instances, the input comprises a selection of a region containing several objects. In other embodiments, the input comprises one or more selections and/or visual cues created by a local user relating to a particular object or objects.

At step 1306, the computer system 1200 transmits the video content (the video stream) of the surrounding environment along with the visual cue data (e.g., visual cue data 806 shown in FIG. 8) relating to the selected portions to one or more remote computing devices.

At step 1308, remote selections of portions of the video content/video stream are received at the local device (e.g., device 106 from FIG. 1), along with a time signature (e.g., visual cue data 808 shown in FIG. 8) corresponding to when the remote selections were made. In some instances, the remote selections comprise a selection of a region containing several objects. In other embodiments, the remote selection comprises one or more selections and/or visual cues created by a remote user relating to a particular object or objects.

At step 1310 the detection module 1226 detects objects within the remote selection in the video content at the time indicated in the time signature. The detection module 1226 then determines the new location of that object in the current video frame being displayed on the local device (e.g., device 106 from FIG. 1) at step 1312.

At step 1314, the transform module 1220 (which implements the visual cue transformation module 809) transforms the remote visual cue data in accordance with the new location of the objects. The local device accesses a video buffer (e.g., video buffer 807 of FIG. 8) in order to retrieve the frame corresponding to the timestamp contained in the visual cue data to compare whether the object in the vicinity of the remote visual cue data has moved from its original location. In some instances, the visual cues from remote devices are transformed in accordance with predicted motion of the local device or predicted motion of the object in the vicinity of the visual cues created by the remote user.

At step 1316, the display module 1222 displays the remote selections and the user-selected portions on the user device. Thus, the user of a local device can view remote and local visual cues, gain instruction on purchasing an item, or input regarding important objects in the user's surrounding environment. The method terminates at step 1318.

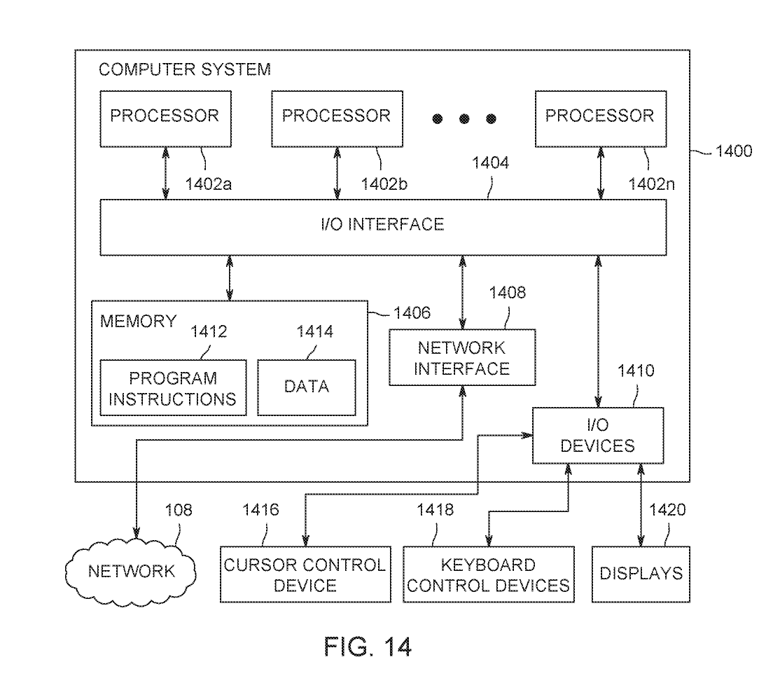

FIG. 14 depicts a computer system 1400 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 1400 illustrated by FIG. 14, which may in various embodiments implement any of the elements or functionality illustrated in FIG. 1. In various embodiments, computer system 1400 may be configured to implement methods described above. The computer system 1400 may be used to implement any other system, device, element, functionality or method of the above-described embodiments. In the illustrated embodiments, computer system 1400 may be configured to implement method 1300 as processor-executable program instructions 1422 (e.g., program instructions executable by processor(s) 1410) in various embodiments.

In the illustrated embodiment, computer system 1400 includes one or more processors 1410a-1410n coupled to a system memory 1420 via an input/output (I/O) interface 1430. Computer system 1400 further includes a network interface 1440 coupled to I/O interface 1430, and one or more input/output devices 1450, such as cursor control device 1460, keyboard 1470, and display(s) 1480. In various embodiments, any of the components may be utilized by the system to receive user input described above. In various embodiments, a user interface may be generated and displayed on display 1480. In some cases, it is contemplated that embodiments may be implemented using a single instance of computer system 1400, while in other embodiments multiple such systems, or multiple nodes making up computer system 1400, may be configured to host different portions or instances of various embodiments. For example, in one embodiment some elements may be implemented via one or more nodes of computer system 1400 that are distinct from those nodes implementing other elements. In another example, multiple nodes may implement computer system 1400 in a distributed manner.

In different embodiments, computer system 1400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 1400 may be a uniprocessor system including one processor 1410, or a multiprocessor system including several processors 1410 (e.g., two, four, eight, or another suitable number). Processors 1410 may be any suitable processor capable of executing instructions. For example, in various embodiments processors 1410 may be general-purpose or embedded processors implementing any of a variety of instruction set architectures (ISAs). In multiprocessor systems, each of processors 1410 may commonly, but not necessarily, implement the same ISA.

System memory 1420 may be configured to store program instructions 1422 and/or data 1432 accessible by processor 1410. In various embodiments, system memory 1420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 1420. In other embodiments, program instructions and/or data may be received, sent or stored upon different types of computer-accessible media or on similar media separate from system memory 1420 or computer system 1400.

In one embodiment, I/O interface 1430 may be configured to coordinate I/O traffic between processor 1410, system memory 1420, and any peripheral devices in the device, including network interface 1440 or other peripheral interfaces, such as input/output devices 1450. In some embodiments, I/O interface 1430 may perform any necessary protocol, timing or other data transformations to convert data signals from one component (e.g., system memory 1420) into a format suitable for use by another component (e.g., processor 1410). In some embodiments, I/O interface 1430 may include support for devices attached through various types of peripheral buses, such as a variant of the Peripheral Component Interconnect (PCI) bus standard or the Universal Serial Bus (USB) standard, for example. In some embodiments, the function of I/O interface 1430 may be split into two or more separate components, such as a north bridge and a south bridge, for example. Also, in some embodiments some or all of the functionality of I/O interface 1430, such as an interface to system memory 1420, may be incorporated directly into processor 1410.

Network interface 1440 may be configured to allow data to be exchanged between computer system 1400 and other devices attached to a network (e.g., network 1490), such as one or more external systems or between nodes of computer system 1400. In various embodiments, network 1490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1450 may, in some embodiments, include one or more display terminals, keyboards, keypads, touchpads, scanning devices, voice or optical recognition devices, or any other devices suitable for entering or accessing data by one or more computer systems 1400. Multiple input/output devices 1450 may be present in computer system 1400 or may be distributed on various nodes of computer system 1400. In some embodiments, similar input/output devices may be separate from computer system 1400 and may interact with one or more nodes of computer system 1400 through a wired or wireless connection, such as over network interface 1440.

In some embodiments, the illustrated computer system may implement any of the methods described above, such as the methods illustrated by the flowchart of FIG. 8-9 and FIG. 13. In other embodiments, different elements and data may be included.

Those skilled in the art will appreciate that computer system 1400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 1400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1400 may be transmitted to computer system 1400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for collaborative video sharing comprising:
transmitting a video stream captured by a local device to one or more remote devices;
receiving, at the local device, remote visual cue data related to the video stream from the one or more remote devices, wherein the remote visual cue data comprises one or more visual cues associated with objects identified in the video stream by users of the one or more remote devices;
transforming the visual cue data to correctly position the one or more visual cues with an updated location of the objects in the video stream at the local device; and
superimposing the one or more visual cues over the video stream displaying on the local device continuously as a user of the local device relocates the local device.

2. The method of claim 1, further comprising:
transmitting local visual cue data relating to the video stream to the one or more remote devices for display on the one or more remote devices.

3. The method of claim 1, wherein the video stream is of an environment local to the local device.

4. The method of claim 1, wherein the user sends invitations to view and add visual cues to the video stream.

5. The method of claim 1, wherein the user allows the video stream to be publicly accessible.

6. The method of claim 1, further comprising:
relocating the visual cues in the video stream displayed on the local device based on timestamps for visual registration of object locations.

7. The method of claim 6, wherein the one or more visual cues are associated with at least one creation timestamp.

8. The method of claim 1, further comprising:
performing motion prediction on the local device to determine a new location for the one or more visual cues based on a new location of the objects after movement of the local device; and
superimposing the visual cues on the video stream at the new location.

9. The method of claim 8, further comprising:
storing the video stream in a video buffer at the local device in case of a time delay of reception of the remote visual cue data.

10. The method of claim 1, wherein superimposing the visual cue comprises:
detecting an object in a vicinity of the one or more visual cues at a timestamp of creation of the visual cue;
determining if the object corresponding to the one or more visual cues has moved from a first position by comparing the position of the object at the timestamp in the video stream with a current position of the object in the video stream being currently displayed; and
transforming the one or more visual cues when the object is determined to have moved from the first position to the current position;

11. The method of claim 10, wherein the transforming comprises at least one of:
tracking a position of distinguishing attributes of the object over time by employing a visual tracking algorithm.

12. The method of claim 11, wherein the visual tracking algorithm is one or more of structured output tracking with kernels, or visual tracking with online multiple instance learning.

13. The method of claim 1, further comprising: transmitting a second set of visual cues of the user of the local device to the one or more remote devices.

14. An apparatus for collaborative video sharing comprising:
one or more processors;
memory storing computer instructions for a method executable by the one more processors, the method comprising:
transmitting a video stream captured by a local device to one or more remote devices;
receiving, at the local device, remote visual cue data related to the video stream from the one or more remote devices, wherein the remote visual cue data comprises one or more visual cues associated with objects identified in the video stream by users of the one or more remote devices;
transforming the visual cue data to correctly position the one or more visual cues with an updated location of the objects in the video stream at the local device; and
superimposing the one or more visual cues over the video stream displaying on the local device continuously as a user of the local device relocates the local device.

15. The apparatus of claim 14, the method further comprising:
transmitting local visual cue data relating to the video stream to the one or more remote devices for display on the one or more remote devices.

16. The apparatus of claim 14, wherein the video stream is an environment local to the local device.

17. The apparatus of claim 14, wherein the user sends invitations to view and add visual cues to the video stream.

18. The apparatus of claim 14, wherein the user allows the video stream to be publicly accessible.

19. The apparatus of claim 14, wherein the method further comprises:
relocating the visual cues in the video stream displayed on the local device based on timestamps for visual registration of object locations.

20. The apparatus of claim 19, wherein the one or more visual cues are associated with at least one creation timestamp.
